(19) United States
(12) Patent Application Publication
(10) Pub. No.: US 2024/0181415 A1
(43) Pub. Date: Jun. 6, 2024

(54) Rotating Packed Bed Reactor

(71) Applicant: GTI ENERGY, Des plaines, IL (US)

(72) Inventor: Osman AKPOLAT, Northbrook, IL (US)

(73) Assignee: GTI ENERGY, Des Plaines, IL (US)

(21) Appl. No.: 18/516,019

(22) Filed: Nov. 21, 2023

Related U.S. Application Data
(60) Provisional application No. 63/429,358, filed on Dec. 1, 2022.

(51) Int. Cl. B01J 8/02; B01J 4/00

(52) U.S. Cl. CPC B01J 8/0278; B01J 4/002; B01J 8/0292; B01J 2208/00752; B01J 2208/00902; B01J 2208/028

(57) ABSTRACT

A rotating packed bed reactor and method of use. The rotating packed bed reactor includes a hollow central shaft having two separate concentric liquid pathways therein. The rotating packed bed reactor includes at least two rotating packed beds configured to rotate with the central shaft, and each connected to a different one of the two separate concentric liquid pathways. The central shaft has a first section connected to a first rotating packed bed and a second section connected to a second rotating packed bed, and the second section includes an annular opening to continue a central pathway of the two separate concentric liquid pathways.

### CROSS REFERENCE TO RELATED APPLICATION

This application claims the benefit of U.S. Provisional Application, Ser. No. 63/429,358, filed on 1 Dec. 2022. The co-pending provisional application is hereby incorporated by reference herein in its entirety and is made a part hereof, including but not limited to those portions which specifically appear hereinafter.

### STATEMENT REGARDING FEDERALLY SPONSORED RESEARCH

This invention was made with Government support under DE-FE0031630 awarded by the Department of Energy. The Government has certain rights in this invention.

### BACKGROUND OF THE INVENTION

### Field of the Invention

This invention is directed to a rotating packed bed reactor, and more particularly to a multicomponent and/or multistage rotating packed bed.

### Description of Related Art

Rotating packed bed reactors are typically used to enhance the mass transfer among the gas-liquid-solid phases in a carbonation process. A need exists for a rotating packed bed reactor that permits fluid flow in an efficient manner through a lightweight, tightly packed assembly.

### SUMMARY OF THE INVENTION

The subject invention is directed to a method and apparatus for operating and assembling a rotating packed bed reactor (RPB).

Embodiments of this invention include a RPB with more than one rotating packed bed on a common rotating shaft, and desirably a separate and independent fluid pathway through the common shaft for each of the rotating packed beds. In other words, a first rotating packed bed is connected to a first liquid pathway and a second rotating packed bed is connected to a second liquid pathway, such as extending around the first liquid pathway.

In presently preferred embodiments, the rotating packed bed reactor includes a hollow central shaft having two separate concentric liquid pathways therein. A pair of rotating packed beds are configured to rotate with the central shaft, and each is connected to a different one of the two separate concentric liquid pathways. Additional rotating beds can be added with additional concentric fluid pathways.

In embodiments, an inner path of the two liquid pathways spans from an edge of the RPB to a location of a first rotating packed bed rotor. The outer path of the two liquid pathways spans from the edge to a location of the second rotating packed bed rotor. This rotor preferably includes holes for suitable off the shelf injector nozzle installation. The nozzles are selected based on the process requirements and spray pattern desired.

The end of the shaft preferably includes a rotating liquid coupler that allows the shaft to rotate while making the stationary connections to the liquid transfer tubing. The shaft accordingly delivers liquid into the center of the rotating packed beds and the liquid is sprayed outward into and through the packing.

The spray nozzles are desirably connected to the shaft so that they rotate with the shaft and the RPB rotor. The relative location of the liquid injection with respect to the packing is preferably stationary. The nozzles are desirably radially spaced about the central shaft.

The subject RPB preferably further include a method and apparatus for annular gas transfer from one stage to the second stage for RPB reactors. The gas that will contact the liquid in the second stage preferably exits the first stage at the center of the packed bed. Further, the second stage is preferably connected to the same shaft and includes an annular opening around the shaft where the first and second stage connect.

The exit of the first stage can be inserted into the inlet of the second stage and includes a seal to prevent first stage inlet gas to bypass the RPB and enter second stage. This gas path is preferably sized in diameter to provide low pressure drop, low gas velocity to reduce liquid carryover and minimum gap between the two stages making it very compact.

In embodiments, each of the rotating packed beds includes a packed bed rotor within a stationary outer housing and chamber about the central shaft. The packed bed rotors can be connected to the central shaft by a threaded fastener or a clip. An annular gas passage extends between the rotating packed beds and/or the chambers containing the beds. A gas introduced within a first of the pair of rotating packed beds travels through the annular gas passage to a second of the pair of rotating packed beds. The annular gas passage can be connected to one of the pair of rotating packed beds and inserts into an inlet for an other of the rotating packed beds, such as into the chamber surrounding the second rotating packed bed. The annular gas passage desirably extends about the central shaft, connecting the first stage rotor to the second stage chamber. A second annular gas passage extends between the second rotating packed bed and a stationary gas outlet of the rotating packed bed reactor.

The invention further includes a method of using a rotating packed bed. Embodiments of the method include: introducing a first liquid flow to a first rotating packed bed through a first liquid pathway within a rotating central shaft; introducing a second liquid flow to a second rotating packed bed through a second liquid pathway within the rotating central shaft; and rotating the first and second rotating packed beds by rotating the central shaft to radially introduce each of the first and second liquid flows to a corresponding one of the first and second rotating packed beds from the rotating central shaft. As discussed above, the second liquid pathway desirably extends about and/or separate from the first liquid pathway. The method can further includes steps of introducing a gaseous flow to the first liquid flow in the first rotating packed bed, and introducing the gaseous flow to the second liquid flow in the second rotating packed bed, wherein the gaseous flow passes through an annular gas passage between the first and second rotating packed beds.

Embodiments of this invention further include a rotating packed bed including layers of packing disposed between two outer support plates. Spacers can extend between the two outer support plates and through openings in the packing. The length of the spacer is desirably less than a thickness of the packing, thereby providing compression to the packing by the two outer support plates.

According to a preferred embodiment of this invention, a structured packing spacer system as shown in the figures and/or described herein for the RPB offers several advantages over conventional systems. The structured packing according to this embodiment is very light (to reduce inertia of the rotating equipment) and has a slight compressibility. In one embodiment the packing is made by the commercial manufacturer Montz. The design uses accurately sized cylindrical metal spacers to precisely limit the space between the packing support plates.

When installed and tightened these spacers limit the distance between the two sides or the rotor packing support plates to a predetermined size. This size is slightly smaller than the thickness of the structured packing and thus compresses the packing just enough to seal the side surfaces (where liquid should not flow or channel through) and still prevent it from crushing and restricting the flow through the packing.

In addition, the placement of these spacers through the packing, secures the packing to the rotor and anchors the packing in place and prevents movement due to centrifugal forces. In a preferred embodiment, there are multiple “rings” of spacers locations corresponding to the “rings” of packing material in the rotors.

According to a preferred embodiment of this invention, a method and apparatus for connecting a rotor assembly to the shaft of RPB is shown in the drawings and described as follows.

As described herein, preferred embodiments of this invention permit RPBs to be designed more compactly and operated more reliably. The individual features of the method and apparatus described above also offer the following advantages over traditional systems.

The described method and apparatus for liquid injection through the shaft in rotating RPBs allow liquid and packing to remain stationary with respect to each other and minimize shearing forces on liquid and packing at the entry.

The described method and apparatus for annular gas transfer from one stage to the second stage for RPB reactors permits an overall size reduction of the reactor.

The described method and apparatus for a structured packing spacer system for RPB is secured and sealed to make sure the liquid is moving through the packing in the intended path and not channeling from the edges. Also, since the RPB is typically spinning at about 600+ RPM, the material needs to be secured firmly.

Other objects and advantages will be apparent to those skilled in the art from the following detailed description taken in conjunction with the appended claims and drawings.

### BRIEF DESCRIPTION OF THE DRAWINGS

FIG. 1 shows a side view of a shaft area of a rotating packed bed reactor according to one preferred embodiment of the invention.

FIG. 2 shows a sectional view of a rotating packed bed reactor, along line 2-2 in FIG. 1.

FIG. 2 shows a sectional view of a rotating packed bed reactor, along line 3-3 in FIG. 1.

FIG. 4 shows a cross-sectional partial side view of a shaft assembly of a rotating packed bed reactor according to the embodiment of FIGS. 1-3.

FIG. 5 shows a top view of a rotating packed bed reactor assembly according to one preferred embodiment of the invention.

FIG. 6 is a sectional view of the rotating packed reactor assembly, along lines 6-6 in FIG. 5.

FIGS. 7-9 are each an exploded sectional view taken from FIG. 6.

FIG. 10 shows a c-clip used in embodiments of this invention.

### DETAILED DESCRIPTION

According to a preferred embodiment of this invention, a method and apparatus for liquid injection through a shaft in rotating equipment, including rotating packed bed reactors (RPBs), is shown in the attached figures and described below.

As shown in the attached figures, the RPB generally includes a central shaft that is preferably hollow. A tube or similar passage is preferably inserted and/or positioned in and through a center of the shaft to allow for two, separate, and desirably concentric liquid pathways that go through the shaft.

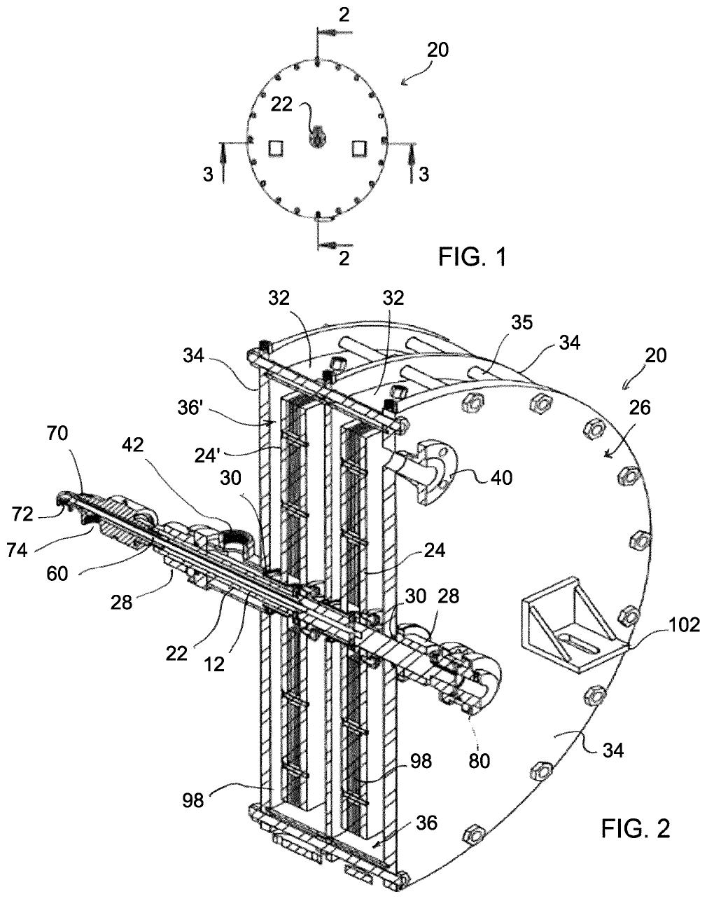

FIG. 1 shows a side or end view of a RPB 20 according to one embodiment of this invention. The RPB 20 includes a central shaft 22, around which one or more packed beds rotate, and through which a liquid is introduced to the one or more packed beds.

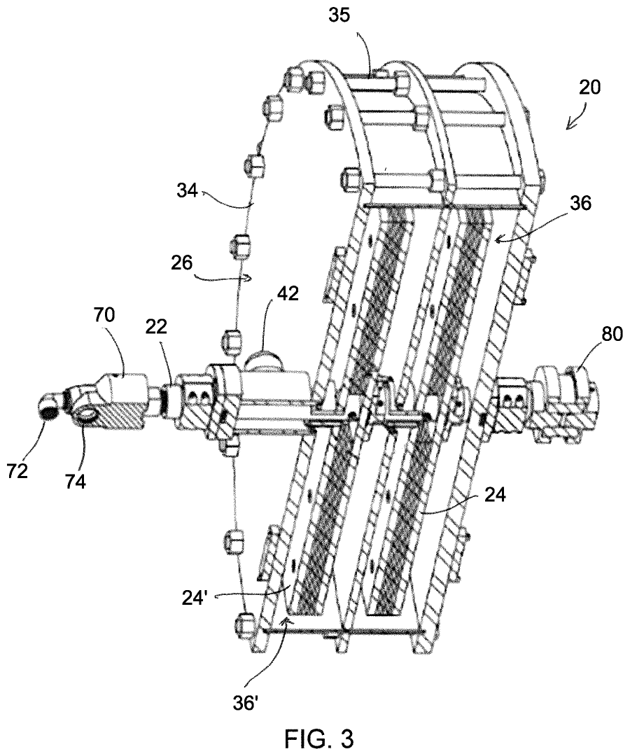

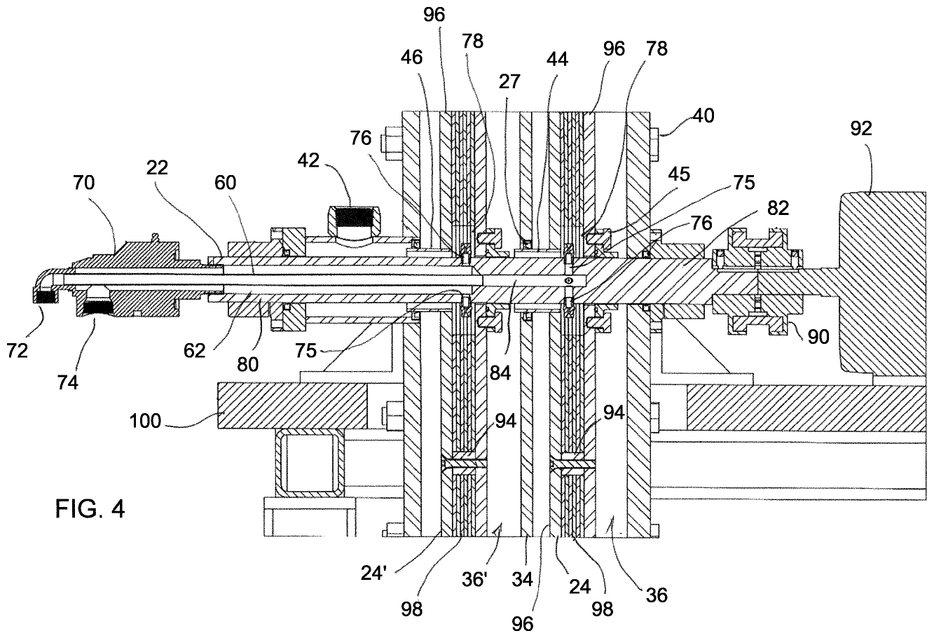

Referring to FIGS. 2-4, the RPB 20 includes two packed bed rotors 24 configured to rotate with and/or around the central shaft 22. The packed bed rotors 24 are contained in a stationary outer housing 26, which can be connected to any suitable support, such as the table 100 shown FIGS. 4-6. The central shaft 22 extends through and is connected to the stationary outer housing 26 by any suitable rotary connection, such as a combination of rotary bearings 28 and rotary seals 30. In the illustrated embodiment, the outer housing 26 is modular, and formed of circular sections 32 between plates 34 held together by bolts 35 to form chambers 36. The packed bed rotors 24 rotate within the chambers 36.

The subject RPB 20 preferably further includes a method and apparatus for annular gas transfer from one stage to the second stage for RPB reactors. The gas that will contact the liquid in the second stage rotor 24′ preferably exits the first stage rotor 24 at the center of the RPB 20. The outer housing 26 includes a gas/vapor inlet 40 and a gas/vapor exhaust pipe 42. A gas or vapor introduced to a first chamber 36 travels through the packing material 98 of the first rotor 24 and then enters the second chamber 36′ through a passage 44 fixed to the rotor(s) 24 and/or the central shaft 22. A similar passage 46 extends from the second chamber 36′ to the outlet 42.

Further, the dividing plate 34 between the chambers 36 includes an annular opening 25 around the shaft 22 where the first and second stages meet. The exit of the first stage rotor 24 includes the passage 44 inserted into or through the annular inlet opening 25 of the dividing plate 34 and includes a seal 27 to prevent first stage inlet gas to bypass the first rotor 24 and enter the second stage. The exit of the second stage rotor 24′ includes an analogous passage 46 that engages with the exhaust passage 42 of the housing 26. These gas paths are preferably sized in diameter to provide low pressure drop, low gas velocity to reduce liquid carryover and minimum gap between the two stages making it very compact.

The packed bed rotors 24 can be connected to the central shaft 22 by any suitable means r fastening element. Rotors 24 are preferably mounted to the rotating shaft 22 using a c-clip, such as shown in FIG. 10, in or against a circumferential groove or other surface, and a metal key instead of lock screws or bolts 45. This allows the rotor assemblies to slide into the shaft easily and “find” their correct orientation on the shaft axially, and “lock” onto the shaft using the metal key radially. Such an arrangement simplifies assembly and disassembly, reduces rotor slippage and shearing of the lock screw and prevents failure of the rotor due to disengagement of the rotor from the shaft. In this arrangement, the shaft turns but the rotor does not or is free to spin when the shaft is not turning.

The central shaft 22 is designed to separately deliver a liquid to each of the rotors 24. The central shaft 22 is preferably hollow, with a tube 60 inserted and/or positioned in and through a center of the shaft 22. The tube 60 is connected to one of the rotors 24, in this case the first stage rotor 24, which is in combination with the inlet 42. Preferably a second liquid pathway is connected to the second rotor 24′. The illustrated second pathway is a hollow passage 62 of the shaft 22 through which the tube 60 passes. The hollow passage 62 extends around or about the tube 60. The illustrated embodiment thus provides two, separate, concentric liquid pathways that go through the shaft 22. Only the tube 60 extends through the shaft 22 beyond the second stage rotor 24′, thereby allowing the fluid in tube 60 to be radially ejected into the first rotor 24.

One end of the shaft 22 includes a dual flow rotary union 70 which includes two connections 72 and 74. The first stage connection 72 is connected to the tube 60, and the second stage connection 74 is connected to the surrounding passage 62. The rotary union 70 can be any suitable attachment, such as a rotating joint or siphon.

The inner path, namely tube 60, spans from the rotary union 70 to the first stage rotor 24. The outer path 62 spans from the rotary union 70 to the second stage rotor 24′. Each rotor 24 includes holes 75, desirably radially spaced about the shaft 22, which allow the liquid to exit the shaft 22 from the fluid pathways into the corresponding one of the rotors 24. Each hole 75 desirably includes a nozzle 76 selected for process requirements and desired spray pattern. The spray nozzles 76 are connected to the shaft 22, so they rotate with the shaft 22 and the corresponding rotor 24. The relative location of the liquid injection with respect to the packing is thus, preferably stationary. As shown, there is a space 78 between the nozzle 76 outlet and the packing material 98 to facilitate spraying. The space 78 also facilitates treated gas or vapor passage through the passages 44 and 46.

In embodiments, the central shaft 22 is formed of a first section 80 connected to a first rotor 24 and a second section 82 connected to a second rotor. The first section 82 includes an annular opening 84 that is or continues a central pathway of the tube 60, while providing an end stop to the concentric fluid path 62. The two sections can be attached together or integrally formed. As will be appreciated by those skilled in the art, various sizes, shapes, and configurations are available for the shaft, rotors, and fluid pathways, depending on need. As an example, two tubes can be used for the two fluid pathways, with the second stage tube ending in a concentric chamber about the first stage tube, or otherwise including a tube structure that extends around and/or about the first stage tube. Additional shaft sections can be used to add additional concentric pathways and additional rotors.

The end of the shaft 22 opposite the dual flow rotary union 70 preferably includes a rotating coupler 90 that allows the shaft 22 to rotate, such as by motor 92, while making the stationary connections to the liquid transfer tubing. The shaft 22 accordingly delivers liquid into the center of the rotating packed beds 24 and the liquid is sprayed to the packing.

Embodiments of this invention, such as shown in the figures, provide an improved structured packing spacer system. Each rotor 24 includes a structured packing 98 that is lightweight (to reduce inertia of the rotating equipment) and has a slight compressibility. The rotors 24 use accurately sized cylindrical metal spacers 94 to precisely limit the space between the packing support plates 96. When installed and tightened these spacers 94 limit the distance between the two sided or the rotor packing support plates 96 to a predetermined size. This size is slightly smaller than the thickness of the structured packing 98 therebetween, and thus compresses the packing 98 just enough to seal the side surfaces (where liquid should not flow or channel through) and still prevent it from crushing and restricting the flow through the packing 98.

In addition, the placement of these spacers 94 through the packing 98, secures the packing 98 to or within the rotor 24 and anchors the packing 98 in place and prevents movement due to centrifugal forces. In a preferred embodiment, there are multiple “rings” of spacers 94 locations corresponding to the “rings” of packing material 98 in the rotors 24.

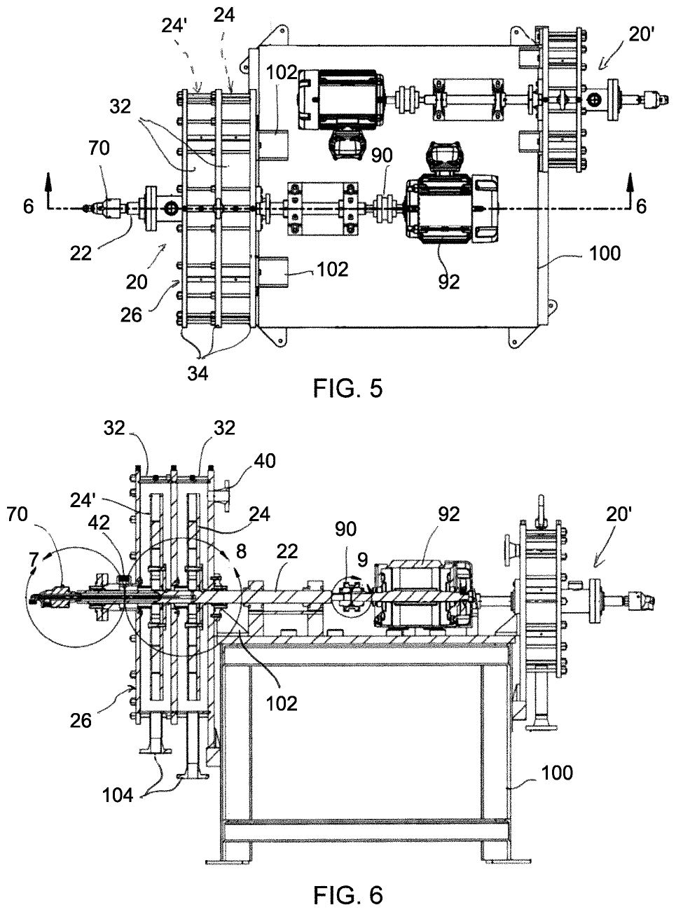

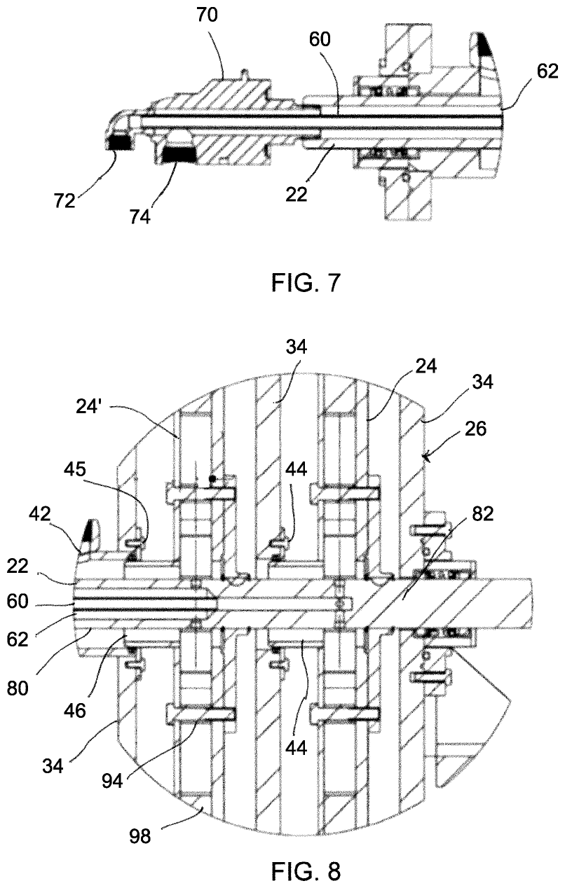

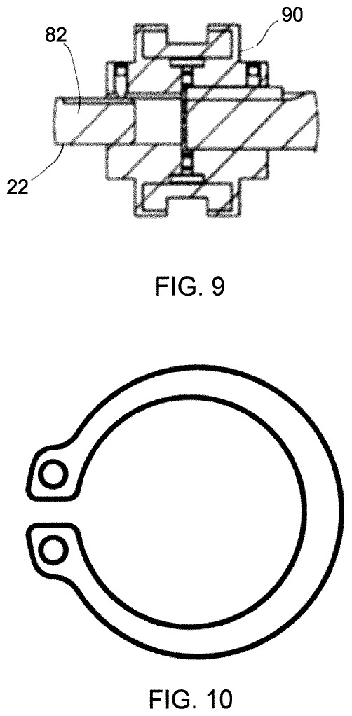

As described herein, preferred embodiments of this invention permit RPBs to be designed more compactly and operated more reliably. FIGS. 5 and 6 show the RPB 20 attached to table 100, using brackets 102. A second RPB 20′, having only one stage of packed bed, is shown as also being connected to table 100.

Operation of the rotating packed bed reactor 20 involves introducing a first liquid flow to the first rotating packed bed 24 through the first liquid pathway 60 within the rotating central shaft 22. A second fluid flow of a same or different fluid is introduced to the second rotating packed bed 24′ through the second liquid pathway 62 within the rotating central shaft 22. The two rotating packed beds 24 are rotated together by rotation of the central shaft 22, which radially introduces each of the first and second liquid flows to the corresponding one of the first and second rotating packed beds 24 from the rotating central shaft 22.

A gaseous flow is introduced to the first rotating packed bed 24 through gas inlet 40. The gaseous flow mixes with, and/or passes through, the first liquid flow in the first rotating packed bed 24. The gaseous flow passes to the second liquid flow in the second rotating packed bed 24, via the annular gas passage 44 between the first and second rotating packed beds 24. The gaseous flow mixes with, or passes through the second liquid flow in the second rotating packed bed 24. The treated gaseous flow then exits the reactor 20 through the annular gas passage 46 and the outlet 42. The liquid within the reactor 20 is drained from the housing chambers 36 by any suitable outlet, such as drain outlets 104.

The individual features of the method and apparatus described above also offer the following advantages over traditional systems.

The described method and apparatus for liquid injection through the shaft in rotating RPBs allow liquid and packing to remain stationary with respect to each other and minimize shearing forces on liquid and packing at the entry.

The described method and apparatus for annular gas transfer from one stage to the second stage for RPB reactors permits an overall size reduction of the reactor.

The described method and apparatus for a structured packing spacer system for RPB is secured and sealed to make sure the liquid is moving through the packing in the intended path and not channeling from the edges. Also, since the RPB is typically spinning at about 600+ RPM, the material needs to be secured firmly.

The described method and apparatus for connecting the rotor assembly to the shaft of RPB provides easy replacement of rotor assembly, maintenance, and attachment.

While in the foregoing detailed description the subject development has been described in relation to certain preferred embodiments thereof, and many details have been set forth for purposes of illustration, it will be apparent to those skilled in the art that the subject development is susceptible to additional embodiments and that certain of the details described herein can be varied considerably without departing from the basic principles of the invention.

What is claimed is:

1. A rotating packed bed reactor comprising:
a hollow central shaft having two separate concentric liquid pathways therein.

2. The rotating packed bed reactor of claim 1, further comprising a pair of rotating packed beds configured to rotate with the central shaft, and each connected to a different one of the two separate concentric liquid pathways.

3. The rotating packed bed reactor of claim 2, wherein the central shaft comprises a first section connected to a first of the pair of rotating packed beds and a second section connected to a second of the pair of rotating packed beds, and the second section includes an annular opening to continue a central pathway of the two separate concentric liquid pathways.

4. The rotating packed bed reactor of claim 2, wherein each of the rotating packed beds comprises a packed bed rotor within a stationary outer housing, the packed bed rotor connected to the central shaft by a threaded fastener or a clip.

5. The rotating packed bed reactor of claim 1, further comprising an annular gas passage between the pair of rotating packed beds, wherein a gas introduced within a first of the pair of rotating packed beds travels through the annular gas passage to a second of the pair of rotating packed beds.

6. The rotating packed bed reactor of claim 5, wherein the annular gas passage is connected to one of the pair of rotating packed beds and inserts into an inlet for an other of the rotating packed beds.

7. The rotating packed bed reactor of claim 5, wherein the annular gas passage extends about the central shaft, and has a diameter configured to provide low pressure drop, low gas velocity to reduce liquid carryover, and minimum gap between the pair of rotating packed beds.

8. The rotating packed bed reactor of claim 5, further comprising a second annular gas passage between second of the pair of rotating packed beds and a gas outlet of the rotating packed bed reactor.

9. The rotating packed bed reactor of claim 1, further comprising
a first rotating packed bed, wherein a first liquid pathway connects to the first rotating packed bed; and
a second rotating packed bed, wherein a second liquid pathway extends around the first liquid pathway and connects to the second rotating packed bed.

10. The rotating packed bed reactor of claim 1, wherein an end of the central shaft comprises a rotating liquid coupler configured to allow the central shaft to rotate and providing a stationary connection to one or more liquid transfer tubing.

11. The rotating packed bed reactor of claim 1, wherein the concentric liquid pathways deliver liquid into a center of two adjacent rotating packed beds and the liquid is sprayed into packing within the rotating packed beds.

12. The rotating packed bed reactor of claim 1, wherein the central shaft rotates about a longitudinal axis, and includes radially disposed nozzle connections.

13. The rotating packed bed reactor of claim 1, further comprising spray nozzles connected to the central shaft, wherein the spray nozzles rotate with the central shaft and a relative location of a liquid injection with respect to packing within the packed bed reactor is stationary.

14. The rotating packed bed reactor of claim 1, further comprising a rotating packed bed about the central shaft, the rotating packed bed including layers of packing disposed between two outer support plates.

15. The rotating packed bed reactor of claim 14, further comprising spacers extending between the two outer support plates and through openings in the packing.

16. The rotating packed bed reactor of claim 15, wherein the length of the spacer is less than a thickness of the packing, thereby providing compression to the packing by the two outer support plates.

17. A method of using a rotating packed bed, the method comprising:
introducing a first liquid flow to a first rotating packed bed through a first liquid pathway within a rotating central shaft;
introducing a second liquid flow to a second rotating packed bed through a second liquid pathway within the rotating central shaft;
rotating the first and second rotating packed beds by rotating the central shaft to radially introduce each of the first and second liquid flows to a corresponding one of the first and second rotating packed beds from the rotating central shaft.

18. The method of claim 17, wherein the second liquid pathway extends about and separate from the first liquid pathway.

19. The method of claim 17, further comprising:
introducing a gaseous flow to the first liquid flow in the first rotating packed bed;
introducing the gaseous flow to the second liquid flow in the second rotating packed bed, wherein the gaseous flow passes through an annular gas passage between the first and second rotating packed beds.
